(19) United States
(12) Patent Application Publication
(10) Pub. No.: US 2003/0061354 A1
(43) Pub. Date: Mar. 27, 2003

(54) DELIVERY OF CALL QUEUE MESSAGES FOR CALLS LAUNCHED FROM THE INTERNET

(75) Inventors: FREDERICK MURRAY BURG, WEST LONG BEACH, NJ (US); LEV SLUTSMAN, ASBURY PARK, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD COMPANY & INTEL CORPORATION

(21) Appl. No.: 09/428,363

(22) Filed: Oct. 27, 1999

(51) Int. Cl. G06F 15/16; H04L 12/54

(52) U.S. Cl. 709/227; 370/428

(57) ABSTRACT

A call is set up between a subscriber premises and a call center. The subscriber premises includes a personal computer and a telephone. A call set up request is received from a gateway responsive to the personal computer of the subscriber premises. A query is sent to the call center. An availability reply is received from the call center, and a call set up instruction is prepared for setting up the call between the telephone of the subscriber premises and the call center. In some cases, an unavailability reply is received from the call center. The time-in-queue until the call center will be available to receive the call is estimated, and a call queue status message is prepared for delivery to the gateway and thence to the subscriber premises.

### BACKGROUND OF THE INVENTION

The present invention relates to notifying a telecommunication network customer of call status, and more particularly, is directed to transporting, via the Internet, a message regarding a queue length for a call waiting for service at a call center.

Telemarketing, the sale of products and services to customers over the telephone, is one of the fastest growing businesses around the world. In a typical call center, telemarketing agents are equipped with a telephone terminal for answering telephone calls placed by customers. Typically, call centers have toll-free numbers such as “800” numbers.

FIG. 1 shows a configuration for telemarketing including telephone 10, assumed to be at a customer premises, telecommunication network 20, and corporate premises 80. Telecommunication network 20 includes switch 30, service control point (SCP) 40, and intelligent peripheral (IP) 50. Network 20 may be the public switched telephone network (PSTN). Corporate premises 80 includes private branch exchange (PBX) 60 coupled to call center 70. PBX 60 and call center 70 may be co-located or in different locations.

SCP 40 includes a computer programmed to queue calls waiting for service at call center 70 inside telecommunication network 20, to estimate the time-in-queue for an enqueued call, and to notify enqueued callers of their estimated time-in-queue.

PBX 60 includes queue manager 64 and router 62. Queue manager 64 queues and dequeues incoming calls from telecommunication network 20 based on an appropriate queue discipline, such as first in first out. Router 62 routes calls to call center 70 for delivery to an appropriate agent using a skill matrix or other criteria. Call center 70 is an automatic call distribution (ACD) system for coupling calls from PBX 60 to agents at stations 72, 74, 76.

FIGS. 2A-2C are flow charts illustrating operation of the configuration of FIG. 1.

Referring to FIG. 2A, at step 205, a user places a call to call center 70 using telephone 10 by dialing a toll-free number of call center 70.

At step 210, switch 30 in telecommunication network 20 receives the dialed number from telephone 10. At step 215, switch 30 determines that the number is a toll-free number, that is, an “800”,“888” or similar number. At step 220, switch 30 requests instructions for the received toll-free number from SCP 40.

At step 225, SCP 40 receives the toll-free number from switch 30. At step 230, SCP 40 retrieves a stored record for the toll-free number. The stored record for the toll-free number includes an actual phone number and information including whether the called phone number has “call center with queue length” service.

Let it be assumed that the called phone number has “call center with queue length” service, and that the called telephone number is associated with PBX 60. At step 235, SCP 40 queries queue manager 64 of PBX 60 as to whether a new call can be immediately connected to call center 70.

At step 240, queue manager 64 receives the query from SCP 40. At step 245, queue manager 64 determines whether a new call can be accommodated by call center 70, such as by checking whether the number of calls in progress is less than the maximum which can be accommodated by call center 70. If the call from telephone 10 can be connected immediately, processing proceeds to step 300 in FIG. 2C.

Let it be assumed that a call cannot be immediately connected. At step 250, queue manager 64 sends an unavailability reply to SCP.

At step 255, SCP 40 receives the unavailability reply from queue manager 64. Referring now to FIG. 2B, at step 260, upon receiving the message from queue manager 64 that a new call cannot be immediately accommodated, SCP 40 instructs IP 50 to execute a stored program to deliver an announcement to telephone 10. Specifically, SCP 40 sends a predetermined type of message accompanied by information to be included in the announcement, such as estimated time-in-queue.

At step 265, IP 50 receives the instruction to deliver the announcement from SCP 40. At step 270, IP 50 delivers the announcement to switch 30. The announcement is a message reflecting the information sent at step 260 such as, “There are two calls ahead of you, and your call should be connected in 4 minutes,” or a pre-recorded message selected in accordance with the information sent at step 260.

Meanwhile, at step 275, SCP 40 instructs switch 30 to connect the call from telephone 10 to IP 50. It will be appreciated that step 275 is performed substantially simultaneously with step 260.

At step 280, switch 30 receives the call connection instruction from SCP 40. At step 285, in response to the call connection instruction from SCP 40, switch 30 switches the call from telephone 10 to port 31 for coupling to IP 50. At step 290, a call path is established where intelligent peripheral 50 plays an announcement for telephone 10.

At step 276, SCP 40 checks whether a predetermined amount of time has elapsed since telephone 10 has been connected to IP 50. If not, then the check at step 276 is repeated. After the predetermined amount of time has elapsed, processing proceeds to step 279.

Let it now be assumed that, at step 296 of FIG. 2B, call center 70 determines that an agent is free to service a new call, and so notifies queue manager 64. At step 297, queue manager 64 forwards the agent availability notice to SCP 40.

At step 277, SCP 40 receives the notice of an available agent. At step 278, SCP 40 determines whether there are calls which have been enqueued longer than the call from telephone 10. If not, then the call from telephone 10 can be connected to call center 70, and processing proceeds to step 330 of FIG. 2C. If there are calls ahead of the call from telephone 10, then processing proceeds to step 279 of FIG. 2B.

At step 279, SCP 40 prepares an update announcement, reflecting its new estimated time-in-queue for the call. The estimate is based on the number of calls accepted by PBX 60 since an announcement was last played to the enqueued caller and/or decrementing the estimated time-in-queue to reflect passage of time. SCP 40 sends its updated announcement information to IP 50. At step 271, IP 50 receives the updated announcement, and proceeds to step 270 to generate an appropriate announcement and deliver it to telephone 10. Meanwhile, SCP 40 proceeds to step 276 and waits for time to pass or an agent availability message to arrive from queue manager 64.

Referring now to FIG. 2C, at step 300, queue manager 64 sends an availability reply to SCP 40. At step 305, which may be performed substantially simultaneously with step 300, queue manager 64 instructs router 62 to switch the incoming call to call center 70 for delivery to an available agent.

At step 310, router 62 receives the instruction from queue manager 64. At step 312, a voiceband connection is established between an available agent at call center 70 and PBX 60.

At step 315, router 62 switches the available agent to the incoming call, and, at step 320, a call path is established between telephone 10 and an agent at station 72.

Meanwhile, at step 325, SCP 40 receives the availability reply from queue manager 64. At step 330, SCP 40 instructs IP 50 to stop its announcement.

At step 340, IP 50 receives the instruction from SCP 40 and, at step 345, stops its announcement.

At step 350, SCP 40 instructs switch 30 to connect telephone 10 to port 32 for connection to the telephone number associated with PBX 60, as obtained from the stored record retrieved by SCP 40 at step 225 in FIG. 2A.

At step 355, switch 30 receives the call connection instruction from SCP 40. At step 357, a voiceband connection is established between telephone 10 and port 32, and another voiceband connection is established between port 32 and PBX 60.

At step 360, switch 30 switches the call from telephone 10 to port 32 for connection to PBX 60. At step 365, a call path is established between telephone 10 and an agent at station 72 of call center 70.

At step 370, telephone 10 is coupled to the circuit established to the available agent at station 72 of call center 70.

At step 375, station 72 is coupled to the circuit established to telephone 10.

One problem with the above-described arrangement is that IP 50 is relied upon. There may not be enough intelligent peripherals in telecommunications network 20 to adequately support the call queue message service. Another problem is the large amount of resources consumed in connecting IP 50 to switch 30, when the originating switch does not have a directly connected IP. A further problem is that the above described arrangement ties up the user's telephone and a port on the originating switch.

Accordingly, there is a need for an improved way to deliver call queue information from PBX 60 to the user of telephone 10.

### SUMMARY OF THE INVENTION

In accordance with an aspect of this invention, there is provided a method of and apparatus for setting up a call between a subscriber premises and a call center. A call set up request is received from a gateway responsive to the subscriber premises. A query is sent to the call center. An availability reply is received from the call center, and a call set up instruction is prepared for setting up the call between the subscriber premises and the call center.

In some cases, an unavailability reply is received from the call center. The time-in-queue until the call center will be available to receive the call is estimated, and a call queue status message is prepared for delivery to the gateway and thence to the subscriber premises. The subscriber premises includes a personal computer and a telephone.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a block diagram showing a prior art telemarketing configuration;

FIGS. 2A-2C are a flow chart illustrating operation of the configuration of FIG. 1;

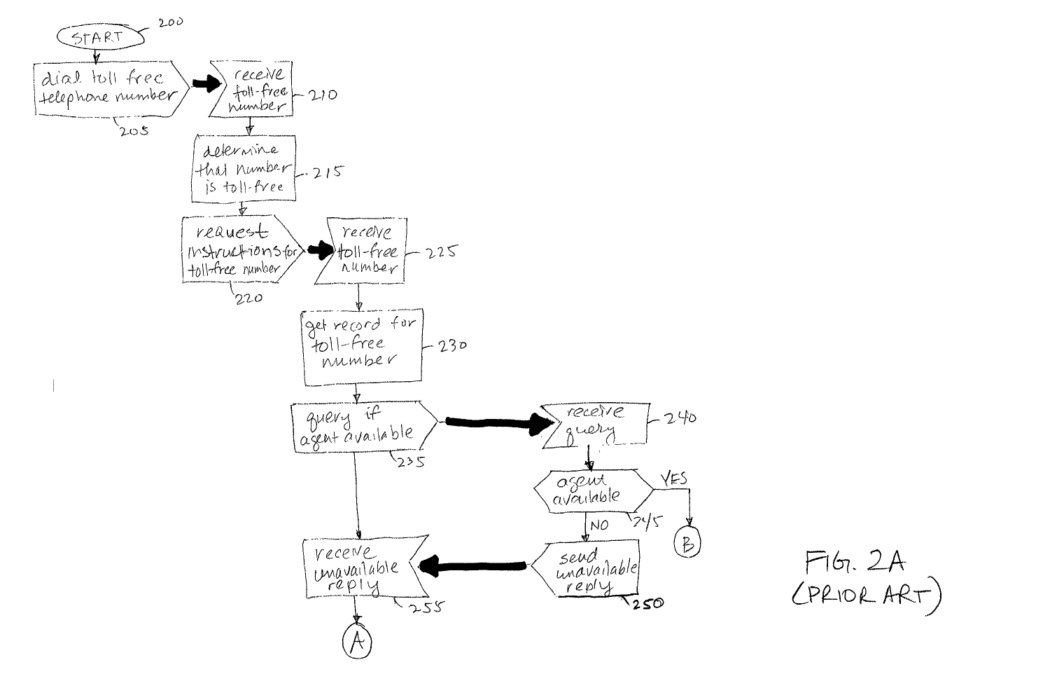

FIG. 3 is a block diagram showing a telecommunication network in which the present invention is applied;

FIG. 4A is a block diagram showing dialer agent 105 residing in personal computer 101;

FIG. 4B is a block diagram showing dialer agent 106 residing in Internet service provider 152;

FIG. 4C is a block diagram showing dialer agent 107 residing in a third party provider or a gateway;

FIGS. 5A-5C are a flow chart illustrating operation of the configuration of FIG. 3;

FIG. 6 is a chart showing a click to dial request; and

FIG. 7 is a chart showing a call set up request sent from gateway 160 to PBX 60.

### DETAILED DESCRIPTION

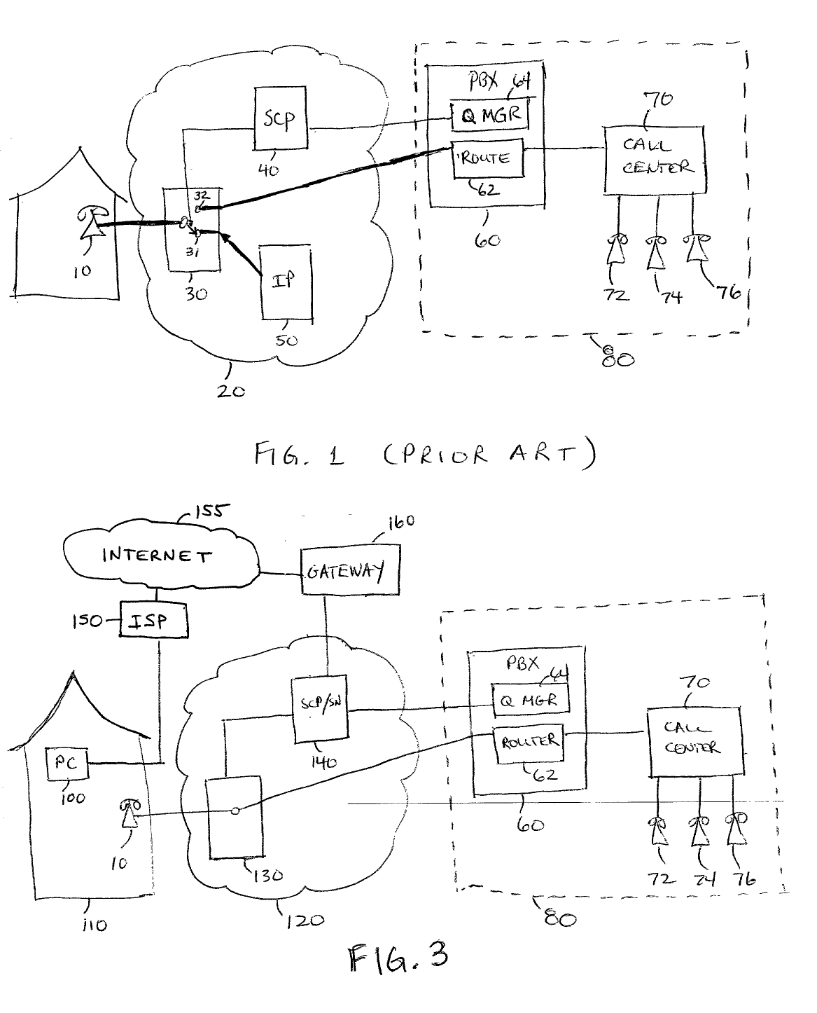

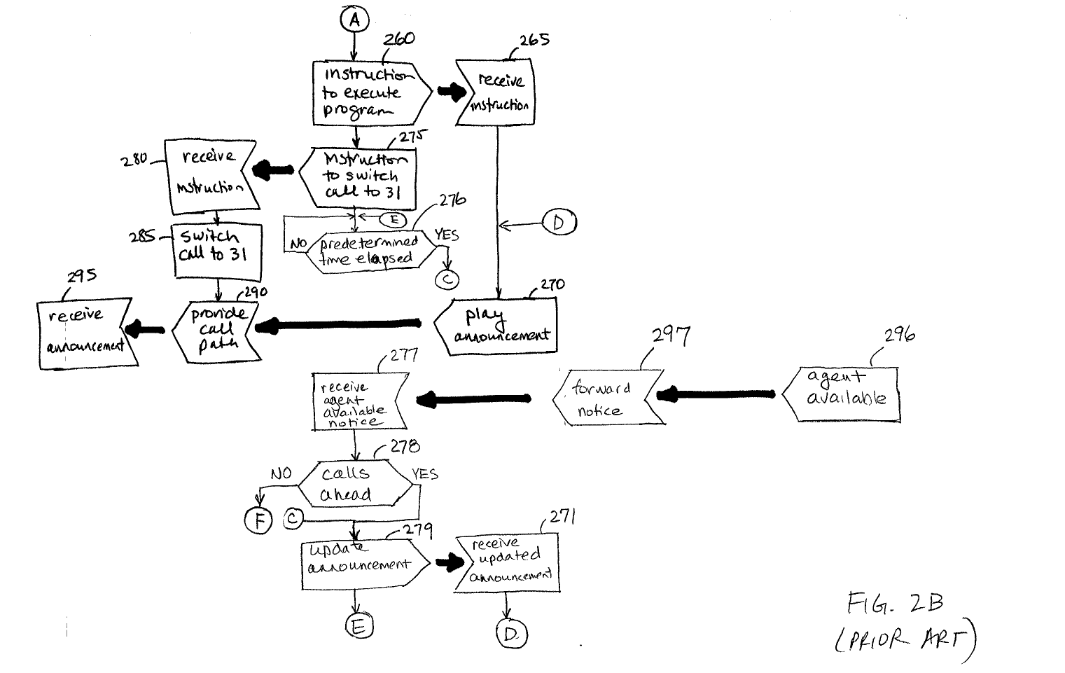

FIG. 3 shows a configuration in which the present invention is applied. The configuration includes subscriber premises 110, telecommunication network 120, Internet service provider (ISP) 150, Internet 155, gateway 160 that couples telecommunication network 120 and ISP 150, and corporate premises 80. Corporate premises 80 is assumed to be substantially the same as in FIG. 1, that is, the present technique is operative with no changes at corporate premises 80.

Subscriber premises 110 includes telephone 10 and personal computer (PC) 100. Telephone 10 is coupled to switch 130 of telecommunication network 120. PC 100 is coupled to ISP 150 via a conventional network connection such as a modem.

In some embodiments, PC 100 is operative using a telephony applications program interface (API) to generate dual tone multi-frequency (DTMF) tones in response to stored or dynamically entered telephone numbers, that is, to act as a “phone dialer”, obviating the need for the subscriber to “dial” a telephone number using the keypad of telephone 10.

FIG. 3 shows an embodiment in which the subscriber has two telephone lines. In other embodiments, the subscriber has only one telephone line and uses an appropriate scheme to provide voice and data services on the single line, such as Voice Over Internet Protocol (IP).

Telecommunication network 120 of FIG. 3 includes switch 130 and service control point (SCP)/service node (SN) 140. SCP/SN 140 includes a general purpose computer programmed to provide SCP functions and SN functions. SCP functions are directed to controlling other network elements such as switch 130, estimating the time-in-queue for an enqueued call, reporting the status of an enqueued call, and so on. SN functions are those necessary to interface with gateway 160 and the SCP functions. In FIG. 3, the SCP and SN functions are shown as colocated. In other embodiments, the SCP and SN functions are located in separate elements of telecommunication network 120. SCP/SN 140 is coupled to switch 130, gateway 160, and queue manager 64 of PBX 60 located at corporate premises 80.

ISP 150 is an Internet service provider such as AT&T Worldnet. In another embodiment, the functions of ISP 150 are provided by a server of a corporation. ISP 150 is coupled to Internet 155.

Gateway 160 is coupled to Internet 155 and SCP/SN 140 of PSTN 150. Gateway 160 functions as an Internet web site for providing a so-called “click to dial” service in which a user initiates a telephone call by clicking on a location of a web page supplied by gateway 160. In particular, gateway 160 translates the user's mouse (or equivalent such as touch pad) click into a call set up request in the conventional format used by PSTN 120.

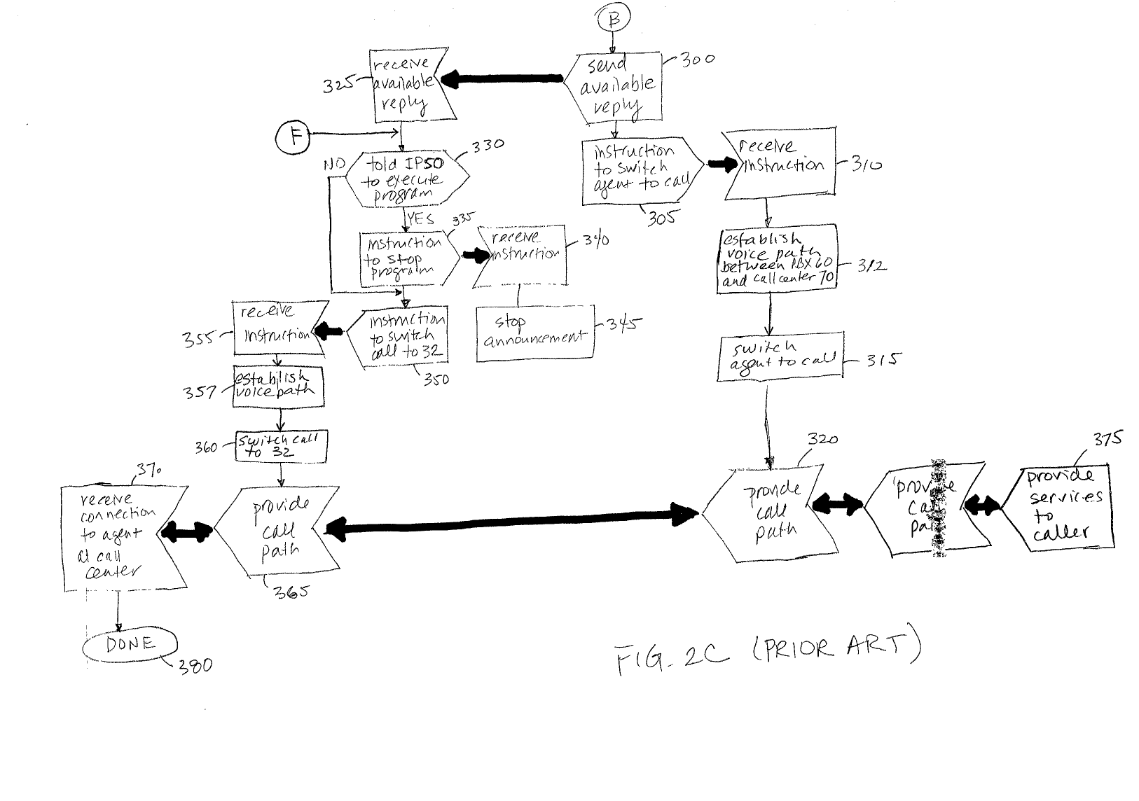

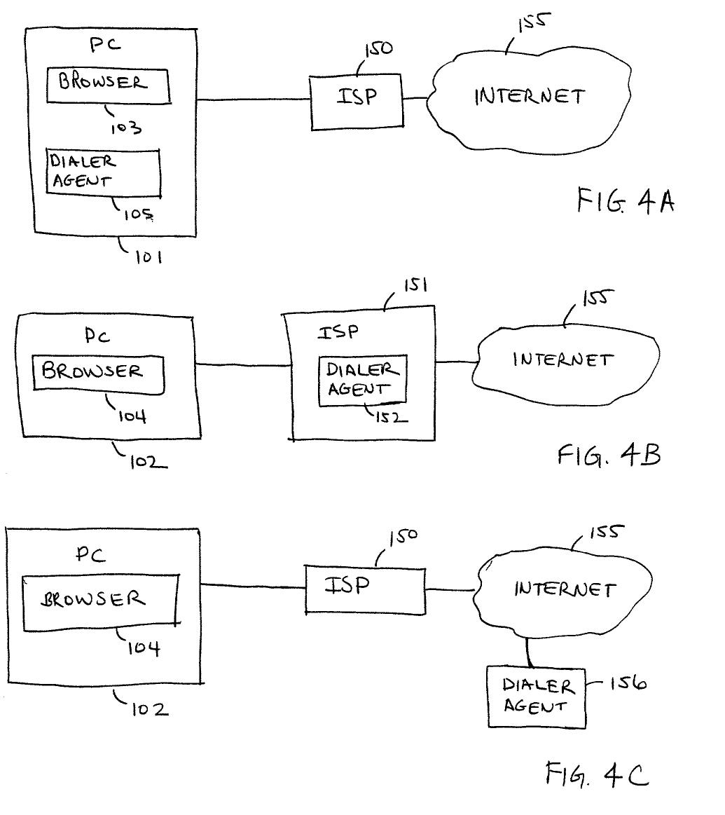

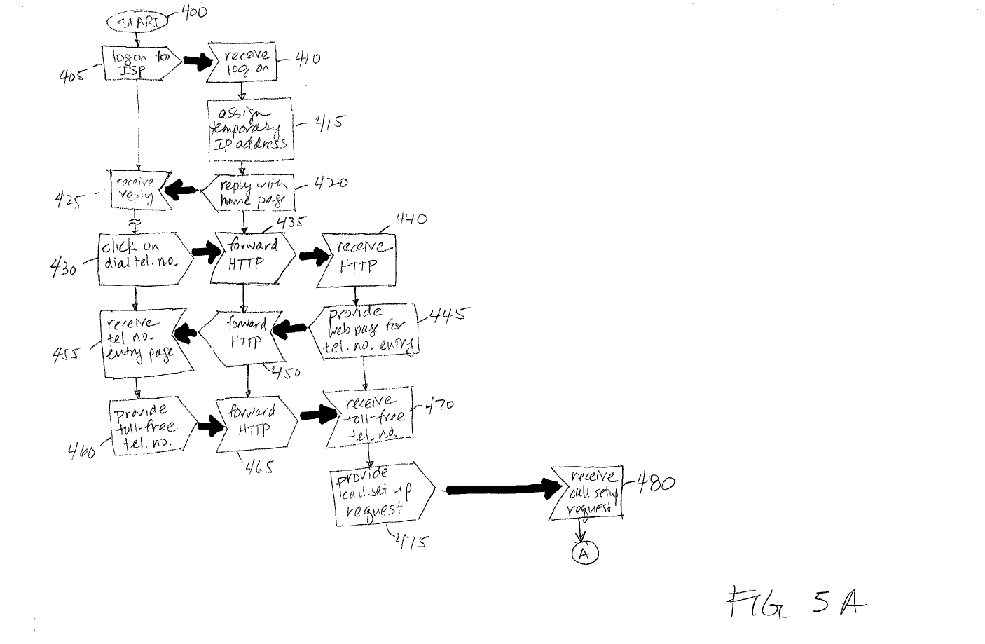

Three possible configurations for placing a call from PC 100 are contemplated: dialer agent 105 resides in PC 101 as shown in FIG. 4A; dialer agent 152 resides in ISP 151 as shown in FIG. 4B; or dialer agent 156 resides in a third party provider or in a gateway accessible through Internet 155, as shown in FIG. 4C.

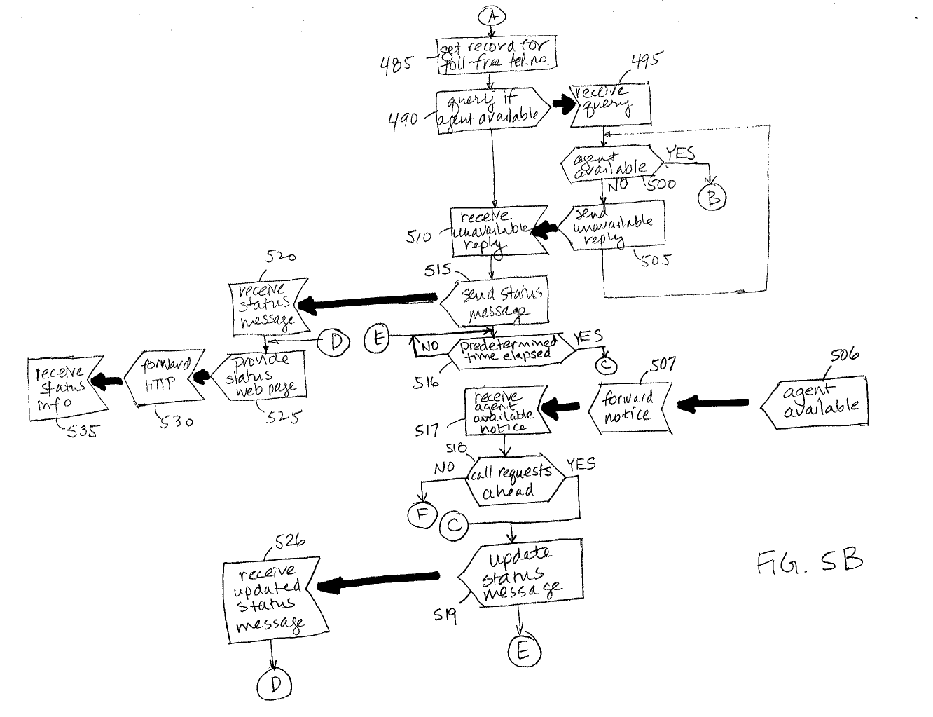

FIGS. 5A-5C are flow charts illustrating operation of the configuration of FIG. 3. FIGS. 5A-5C assume use of a hyper-text transfer protocol (HTTP) request/response architecture. In other embodiments, a Session Initiation Protocol (SIP) architecture is used, as discussed later below.

Referring to FIG. 5A, at step 405, a user uses PC 100 to log on to ISP 150 by establishing a modem connection from PC 100.

At step 410, ISP 150 receives the log on request from PC 100. At step 415, ISP 150 assigns a temporary internet protocol (IP) address to PC 100. At step 420, ISP 150 then replies to PC 100 by providing the home page requested by browser 103, such as an HTTP response including HTML code for the home page selected by the user.

At step 425, PC 100 receives the home page from ISP 150. Next, in activity not shown in FIG. 5A, the user requests the home page of gateway 160, such as by entering the domain address into browser 103 or clicking on a “bookmark” (stored domain address with mnemonic identifier) stored locally in browser 103 or stored at remote location, or clicking on a predefined area of the home page of ISP 150. In response to the user's request, ISP 150 forwards the user's HTTP request packet to gateway 160, which replies with a HTTP response packet including HTML for the home page of gateway 160. At step 430, the user clicks on a predefined area of the home page of gateway 160, such as a “LAUNCH CALL” button. In response to the user's click, browser 103 prepares an appropriate HTTP request packet and sends the packet to ISP 150.

It will be appreciated that if ISP 150 provides a “LAUNCH CALL” button on its homepage, or there is a “personal telephone book” application executing on PC 100, then the user need not receive the home page of gateway 160.

At step 435, ISP 150 forwards the HTTP request packet for launching a telephone call to gateway 160.

At step 440, gateway 160 receives the HTTP request packet for launching a telephone call. At step 445, gateway 160 provides an HTTP request packet including HTML representing a web page for telephone number entry to ISP 150.

At step 450, ISP 150 forwards the HTTP response packet for telephone number entry to PC 100.

At step 455, PC 100 receives the web page for telephone number entry. At step 460, the user enters (i) a toll-free telephone number to the telephone number entry web page to place a call to an agent at call center 70, and (ii) a telephone number, such as the telephone number of telephone 10, at which the user wishes to receive the call from the agent at call center 70. Browser 103 prepares a corresponding HTTP request packet including the toll-free called and reception telephone numbers.

At step 465, ISP 150 forwards the HTTP request packet for the toll-free telephone number to gateway 160.

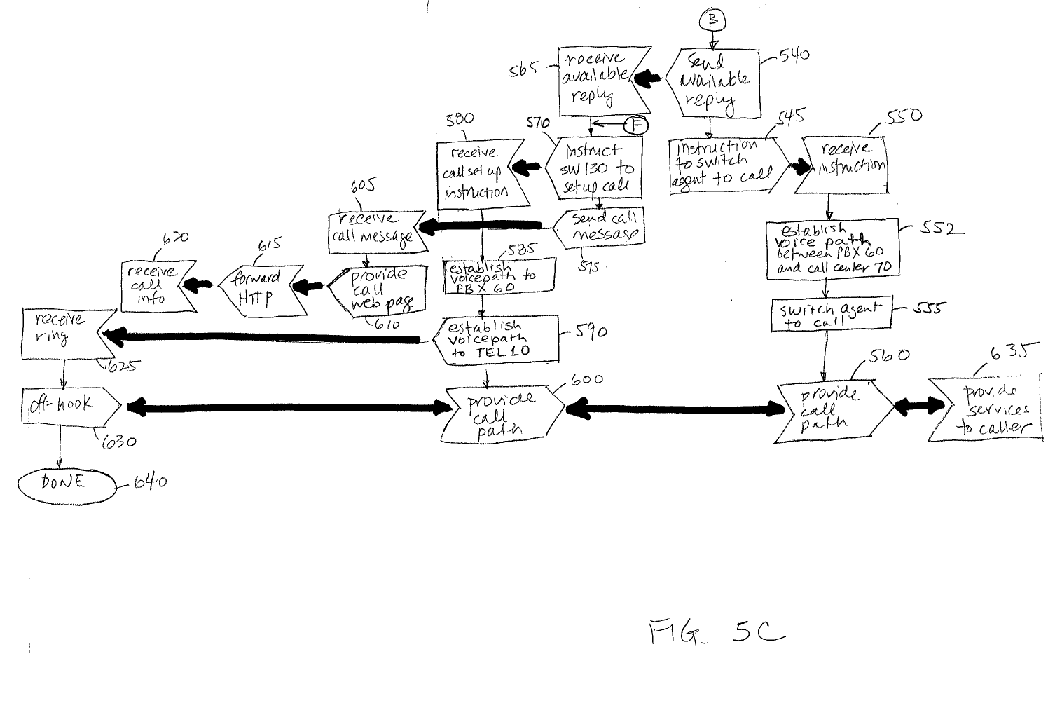

FIG. 6 is a diagram illustrating HTTP request message 700 forwarded to gateway 160 by ISP 150. HTTP request message 700 includes first line 710, second line 720 and third line 730.

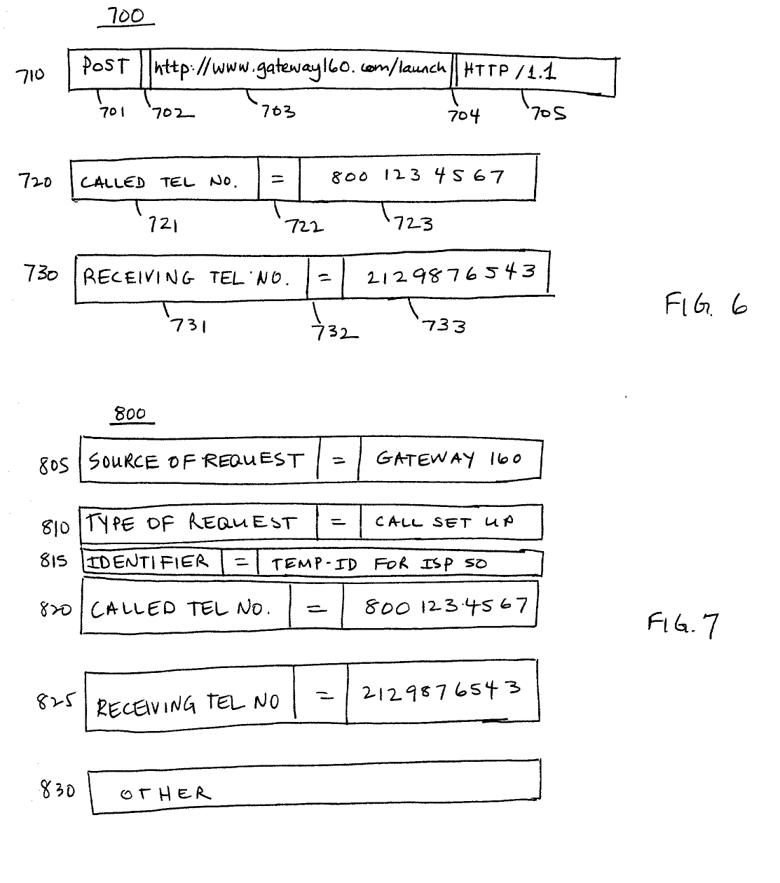

First line 710 is a request-line and includes method field 701, Request-URI field 703, protocol version field 705, and space delimiter (SP) fields 702, 704. Method field 701 indicates the method to be performed on the resource identified by the Request-URI field 703. In HTTP request message 700, the POST method is used to send data entered by the user to a form of a web page. Request-URI field 703 is a uniform resource identifier (URI) upon which to apply the request. HTTP version field 705 indicates the protocol and version for the HTTP request; in FIG. 7, the protocol is seen to be HTTP and the version is “1.1”.

Second line 720 comprises field identifier 721, delimiter 722 and parameter field 723. Field identifier 721 identifies the parameter, herein “called telephone number”.Delimiter field 722 includes the delimiter “=”. Parameter field 723 contains the parameter value, 8001234567, assumed to be the toll-free telephone number of PBX 60.

Third line 730 comprises field identifier 731, delimiter 732 and parameter field 733. Field identifier 731 identifies the parameter, herein “receiving telephone number”.Delimiter field 732 includes the delimiter “=”. Parameter field 733 contains the parameter value, 2129876543, assumed to be the telephone number of telephone 10 of subscriber premises 110 which will receive the call being requested.

At step 470, gateway 160 receives the HTTP request packet for the toll-free number from ISP 150 and, at step 475, gateway 160 assigns a temporary identifier to PC 100 based on its temporary IP address for this call, prepares a call set up request, and delivers the call set up request to SCP/SN 140 of telecommunication network 120. Because PC 100 can launch several calls simultaneously, gateway 160 uses a distinct temporary identifier for each call request.

FIG. 7 is a diagram illustrating the general format of call set up request 800 prepared by gateway 160. Call set up request 800 includes lines 805, 810, 815, 820, 825, 830. Specific call set-up request formats are set forth in International Telecommunications Union (ITU) Recommendation Q.931 (May 1998) ISDN user-network interface layer 3 specification for basic call control, available from www.itu.org, the disclosure of which is hereby incorporated by reference.

Line 805 identifies the source of the call set up request 800. In call set up request 800, the content of line 805 is “gateway 160”.

Line 810 identifies the type of request. In call set up request 800, the content of line 810 is “call set up”.

Line 815 includes the temporary identifier for this call request assigned at step 475.

Line 820 identifies the called telephone number. In call set up request 800, the content of line 820 is the toll-free telephone number of PBX 60, 8001234567 in this example.

Line 825 identifies the receiving telephone number. In call set up request 800, the content of line 825 is the telephone number for telephone 10, 2129876543 in this example.

Line 830 contains other information.

At step 480 of FIG. 5A, SCP/SN 140 receives call set up request 800 for the toll-free number from gateway 160.

Referring now to FIG. 5B, upon receiving call set up request 800 from gateway 160, at step 485, SCP/SN 140 retrieves a stored record for the toll-free telephone number identified in call set up request 800. The stored record for the toll-free number includes an actual telephone number and information including whether the called telephone number has “call center with queue length” service.

Let it be assumed that the called phone number has “call center with queue length” service, and that the actual telephone number is associated with PBX 60. At step 490, SCP/SN 140 queries queue manager 64 of PBX 60 as to whether a new call can be immediately connected to call center 70. As appropriate, SCP/SN 140 interacts with queue manager 64 that has the information regarding the availability of agent stations 72, 74, 76.

Generally, SCP/SN 140 notifies queue manager 64 when there is a new call requesting service. Queue manager 64 responds to a new call notification from SCP/SN 140 by indicating either that the call can be serviced, or that the call must be queued. As an agent becomes available, queue manager 64 advises SCP/SN 140 that an enqueued call can be serviced.

At step 495, queue manager 64 receives the query from SCP/SN 140. At step 500, queue manager 64 determines whether a new call can be accommodated by call center 70, such as by checking whether the number of calls in progress is less than the maximum which can be accommodated by call center 70. If a call can be accommodated, processing proceeds to step 540 of FIG. 5C.

Let it be assumed that a call cannot be immediately connected. At step 505, queue manager 64 sends an unavailability reply to SCP/SN 140 and returns to step 500 to check whether a new call can be accommodated.

At step 510, SCP/SN 140 receives the unavailability reply from queue manager 64. At step 515, SCP/SN 140 sends a status message to gateway 160 regarding the queue length of the call placed by the user from PC 100 and estimating the time-in-queue for the call. For example, the status message contains information such as, “There are three calls ahead of you, and it will be about five minutes until your call is served.” Then, at step 516, SCP/SN 140 checks whether a predetermined amount of time has elapsed, and when it has, proceeds to step 519.

At step 520, gateway 160 receives the call queue status message from SCP/SN 140. At step 525, gateway 160 prepares an HTTP reply packet including HTML representing a web page which includes the call queue status message, and provides the HTTP reply packet to ISP 150.

At step 530, ISP 150 receives the HTTP reply packet for the call queue status information and forwards the HTTP reply packet to PC 100.

At step 535, PC 100 receives the HTTP reply packet and browser 103 displays information regarding the call queue status of the telephone call placed by the user.

The HTTP reply packet prepared by gateway 160 at step 525 need not represent a full web page, and could instead represent a pop-up window for the browser display or a scrolling status line for the browser display. In another embodiment, the HTTP reply packet includes an audio announcement to be played by PC 100.

Let it now be assumed that, at step 506 of FIG. 5B, call center 70 determines that a new call can be serviced, and notifies queue manager 64. At step 507, queue manager 64 forwards this notice to SCP/SN 140.

At step 517, SCP/SN 140 receives notice that another call can be serviced. At step 518, SCP/SN 140 checks whether there are call requests that have been enqueued longer than the call request from PC 100. If not, then processing proceeds to step 570 of FIG. 5C.

If there are call requests ahead of the call request from PC 100, then at step 519, SCP/SN 140 prepares an updated status message for PC 100, such as, “There are two calls ahead of you, and your wait will be about three minutes.” and sends the updated status message to gateway 160. SCP/SN 140 then returns to step 516 to wait for time to pass.

At step 526, gateway 160 receives the status message prepared by SCP/SN 140. Processing proceeds to step 525, resulting in an updated status message being sent to PC 100.

Referring now to FIG. 5C, at step 540, queue manager 64 sends an availability reply to SCP/SN 140. At step 545, which may be performed substantially simultaneously with step 540, queue manager 64 instructs router 62 to connect the call to call center 70 for delivery to an available agent.

At step 550, router 62 receives the call connection instruction from queue manager 64. At step 550, a voiceband connection is established between PBX 60 and call center 70 for the call. At step 555, router 62 connects an available agent to the incoming call, and, at step 560, a call path is established between telephone 10 and an agent at one of stations 72, 74, 76.

Meanwhile, at step 565, SCP/SN 140 receives the availability reply from queue manager 64. At step 570, SCP/SN 140 instructs switch 130 to connect telephone 10 to the telephone number associated with PBX 60, as obtained from the stored record retrieved by SCP/SN 140 at step 485 in FIG. 5B.

At step 575, SCP/SN 140 sends a call status message to gateway 160 for delivery to PC 100.

At step 605, gateway 160 receives the call status message from SCP/SN 140 and, at step 610, creates a corresponding HTTP response packet including appropriate HTML for displaying the call status as a web page, window or status update on a scrolling line of browser 103, and provides the HTTP response packet to ISP 150.

At step 615, ISP 150 forwards the HTTP response packet for the call status to PC 100.

At step 620, PC 100 receives the HTTP response packet and browser 103 displays the call status information to the user of PC 100 indicating that the requested telephone call is being placed.

At step 580, switch 130 receives the call connection instruction from SCP/SN 140. At the start of step 580, switch 130 lacks connections to subscriber premises 110 and corporate premises 80. To establish a circuit switched voice path between telephone 10 of subscriber premises 110 and PBX 60 of corporate premises 80, the control or signaling network of PSTN 120 is utilized by switch 130 to locate and reserve suitable circuit segments. At step 585, switch 130 uses the PSTN signaling network to set up a voiceband connection to PBX 60, and at step 590, switch 130 uses the PSTN signaling network to set up a voiceband connection to telephone 10. At step 600, a call path is established between telephone 10 and PBX 60 which, in turn, is connected to an agent at one of stations 72, 74, 76.

At step 625, telephone 10 receives a ring signal from switch 130 for the call launched from PC 100 at step 460. At step 630, the user picks up the handset of telephone 10 causing telephone 10 to be off-hook, and telephone 10 has a call path to the available agent at corporate premises 80.

The technique of delivering call queue status messages described with reference to FIGS. 5A-5C does not rely on intelligent peripherals in PSTN 120, and thus avoids the prior art problems associated with relying on intelligent peripherals. Another advantage of the present technique is that it does not consume ports on switch 130 or use telephone 10 until an agent at call center 70 is available to service the subscriber.

SIP is an application layer control protocol for creating, modifying and terminating sessions with multiple participants. SIP is independent of the lower layer transport protocol, which is usually TCP/IUDP, but may be ATM AAL5, IPX, frame relay, X.25 or the like. In the SIP architecture, clients send requests, while servers service requests and reply to clients by sending responses. SIP has been published as Internet Engineering Task Force (IETF) standard RFC 2543, available at ftp://ftp.isi.edu/in-notes/rfc2543.txt, the disclosure of which is hereby incorporated by reference.

When SIP is used, PC 100 is a SIP client and gateway 160 is a SIP proxy server. SCP/SN 140 also acts as a SIP proxy server.

Generally, the user of PC 100 clicks an area to establish a telephone connection, as described above with respect to step 430 of FIG. 5A. A SIP URL with the INVITE method can be used as a hyperlink, so the user is typically unaware of whether a connection is being made using HTTP or SIP messages.

Gateway 160 receives the SIP INVITE request message from PC 100 and responds to PC 100 with SIP informational status response such as “100 Trying”,“180 ringing”,“182 Queued, 2 callers ahead” and so on. Functioning as a proxy, gateway 160 forwards the SIP INVITE request to SCP/SN 140.

SCP/SN 140 receives the SIP INVITE message from gateway 160 and responds to gateway 160 with SIP informational status responses as described above. Meanwhile, SCP/SN 140 tries to establish a connection to PBX 60, as described above. When PBX 60 accepts the new call, SCP/SN 140 sends a SIP informational status response to gateway 160 (see step 575 of FIG. 5C), and the voiceband call is established as described in steps 552, 555, 585, 590, 625, 630, 600, 560 and 635 of FIG. 5C. When PBX 60 accepts a new call request, but there are other call requests ahead of the request from PC 110, processing proceeds in similar manner as described above.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A method of setting up a call between a subscriber premises and a call center, comprising:
receiving a call set up request from a gateway responsive to the subscriber premises;
sending a query to the call center;
receiving an availability reply from the call center; and
preparing a call set up instruction for setting up the call between the subscriber premises and the call center.

2. The method of claim 1, further comprising providing a call path between the subscriber premises and the call center.

3. The method of claim 2, wherein a network switch provides the call path in response to the call set up instruction.

4. The method of claim 2, wherein providing a call path includes placing a call to the subscriber premises.

5. The method of claim 2, wherein providing a call path includes placing a call to the call center.

6. The method of claim 1, further comprising receiving an unavailability reply from the call center before receiving the availability reply, estimating the time-in-queue until the call center will be available to receive the call, and preparing a call queue status message for delivery to the gateway.

7. The method of claim 6, further comprising sending the call queue status message to the gateway for delivery to the subscriber premises.

8. The method of claim 6, further comprising:
receiving an agent available notice from the call center, and preparing an updated call queue status message for delivery to the gateway.

9. The method of claim 6, further comprising preparing an updated call queue status message for delivery to the gateway after receiving the availability reply.

10. The method of claim 1, wherein the subscriber premises includes a computer for communicating with the gateway, and a telephone for communicating with the call center.

11. The method of claim 1, further comprising preparing a call connection message relating to the call being set up between the subscriber premises and the call center.

12. The method of claim 11, further comprising sending the call connection message to the gateway for delivery to the subscriber premises.

13. An apparatus for setting up a call between a subscriber premises and a call center, comprising:
means for receiving a call set up request from a gateway responsive to the subscriber premises;
means for sending a query to the call center;
means for receiving an availability reply from the call center; and
means for preparing a call set up instruction for setting up the call between the subscriber premises and the call center.

14. The apparatus of claim 13, further comprising a network switch for providing a call path between the subscriber premises and the call center in response to the call set up instruction.

15. The apparatus of claim 14, wherein the network switch places a call to the subscriber premises.

16. The apparatus of claim 14, wherein the network switch places a call to the call center.

17. The apparatus of claim 13, further comprising means for receiving an unavailability reply from the call center before receiving the availability reply, means for estimating the time-in-queue until the call center will be available to receive the call, and means for preparing a call queue status message for delivery to the gateway.

18. The apparatus of claim 17, further comprising means for sending the call queue status message to the gateway for delivery to the subscriber premises.

19. The apparatus of claim 17, further comprising:
means for receiving an agent available notice from the call center, and
means for preparing an updated call queue status message for delivery to the gateway.

20. The apparatus of claim 17, further comprising means for preparing an updated call queue status message for delivery to the gateway after receiving the availability reply.

21. The apparatus of claim 13, wherein the subscriber premises includes a computer for communicating with the gateway, and a telephone for communicating with the call center station.

22. The apparatus of claim 13, further comprising means for preparing a call connection message relating to the call being set up between the subscriber premises and the call center.

23. The apparatus of claim 22, further comprising means for delivering the call connection message to the gateway for delivery to the subscriber premises.
